(19) United States
(12) Patent Application Publication
(10) Pub. No.: US 2009/0143039 A1
(43) Pub. Date: Jun. 4, 2009

(54) Radio reception apparatus and radio reception method

(75) Inventors: Jiro Ishikawa, Hino-shi (JP); Norio Abe, Hino-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/077,295

(22) Filed: Mar. 18, 2008

(30) Foreign Application Priority Data
Nov. 30, 2007 (JP) 2007-311158

(51) Int. Cl. H04B 1/18

(52) U.S. Cl. 455/273

(57) ABSTRACT

An RSSI detecting unit measures a receiving power level of a signal receive from a base station, and notifies a mode change control unit of the measurement result. A Ec/Io detecting unit measures a Ec/Io level of the signal received from the base station, and notifies the mode change control unit of the measurement result. The mode change control unit discriminates the change of the operation mode in consideration of not only the receiving power level, but also the Ec/Io level, and does not change the Simultaneous-Mode from the Hybrid-Mode unless at least the Ec/Io level exceeds a threshold line.

### CROSS-REFERENCE TO RELATED APPLICATIONS

This application is based upon and claims the benefit of priority from prior Japanese Patent Application No. 2007-311158, filed Nov. 30, 2007, the entire contents of which are incorporated herein by reference.

### BACKGROUND OF THE INVENTION

1. Field of the Invention

The present invention relates to a radio reception apparatus capable of changing two communications bands such as BCMCS (Broadcast/Multicast Services).

2. Description of the Related Art

A radio reception apparatus having a BCMCS function comprises a receiving system using a main antenna and a receiving system using a sub-antenna, and has two communications mode, i.e. Simultaneous-Mode and Hybrid-Mode (cf., for example, Jpn. Pat. Appln. KOKAI Publication No. 2006-033916).

In general, the apparatus is operated in the Simultaneous-Mode. In this mode, the receiving system using the main antenna is employed only for EV-DO communications. The receiving system using the sub-antenna is employed for diversity reception of the receiving system using the main antenna, and receives 1×-paging signal at one time every 5.12 seconds and awaits occurrence of incoming speech. Therefore, since the receiving system using the main antenna is employed only for EV-DO communications, the EV-DO communications capable of continuous data downloading can be carried out.

When a weak field or deterioration in receiving sensitivity occurs, the Simultaneous-Mode is changed to the Hybrid-Mode. In this mode, the EV-DO communications are executed in the receiving system using the main antenna, and the 1×-paging signal is received at one time every 5.12 seconds and the occurrence of incoming speech is awaited. In addition, the receiving system using the sub-antenna is employed for diversity reception of the receiving system using the main antenna. Therefore, since the receiving system using the main antenna is employed for the EV-DO communications and the reception of the 1×-paging signal, downloading the data is interrupted and the EV-DO communications cannot be executed continuously.

For this reason, when the data subjected to the multicast transmissions is received in the Hybrid-Mode, the data is dropped and, consequently, the deterioration in communications quality is thereby caused.

If the conventional radio reception apparatus has the communications mode of changing the signals to be received by one antenna, the apparatus has a problem that the reception of the signals subjected to multicast transmission is interrupted in the communications mode and, consequently, the deterioration in communications quality is thereby caused.

### BRIEF SUMMARY OF THE INVENTION

The present invention has been accomplished to solve the above-described problems. The object of the present invention is to provide an apparatus and method for radio reception, capable of reducing the deterioration in receiving quality of signals subjected to multicast transmission even in a communications mode of changing signals to be received by one antenna.

To achieve the object, an aspect of the present invention is a radio reception apparatus having a first communications mode and a second communications mode and receiving a radio signal from a base station accommodated in a mobile communications network in one of the communications mode. The apparatus comprises a measuring unit which obtains a rate of a desired signal intensity to a full received signal intensity, from a signal received from the base station; and a receiving unit which receives the radio signal from the base station by selectively changing the first communications mode and the second communications mode in accordance with the rate obtained by the measuring unit.

In the present invention, the rate of the desired signal intensity to the full received signal intensity is obtained, and the first communications mode and the second communications mode are selectively changed in accordance with the rate to receive the radio signal from the base station.

Therefore, the present invention can provide a radio reception apparatus and radio reception method, by which even in a communications mode of changing the signals to be received by one antenna, since the communication mode is changed in accordance with the rate of the desired signal intensity to the full received signal intensity, the communication mode can hardly be changed to the communication mode of changing the signals to be received by one antenna as compared with a case of changing the communication mode on the receiving power level, and deterioration of the receiving quality of the signal subjected to the multicast transmission can be reduced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a radio reception apparatus according to an embodiment of the present invention;

FIG. 2 is an illustration showing Simultaneous-Mode and Hybrid-Mode of the radio reception apparatus shown in FIG. 1;

FIG. 3 is an illustration showing a threshold value for discrimination of change between Simultaneous-Mode and Hybrid-Mode of the radio reception apparatus shown in FIG. 1;

FIG. 4 is a flowchart showing a control operation for discrimination of change between Simultaneous-Mode and Hybrid-Mode of the radio reception apparatus shown in FIG. 1; and

FIG. 5 is a block diagram showing a configuration of a radio reception apparatus according to the embodiment of the present invention.

### DETAILED DESCRIPTION OF THE INVENTION

An embodiment of the present invention will be explained below with reference to the accompanying drawings.

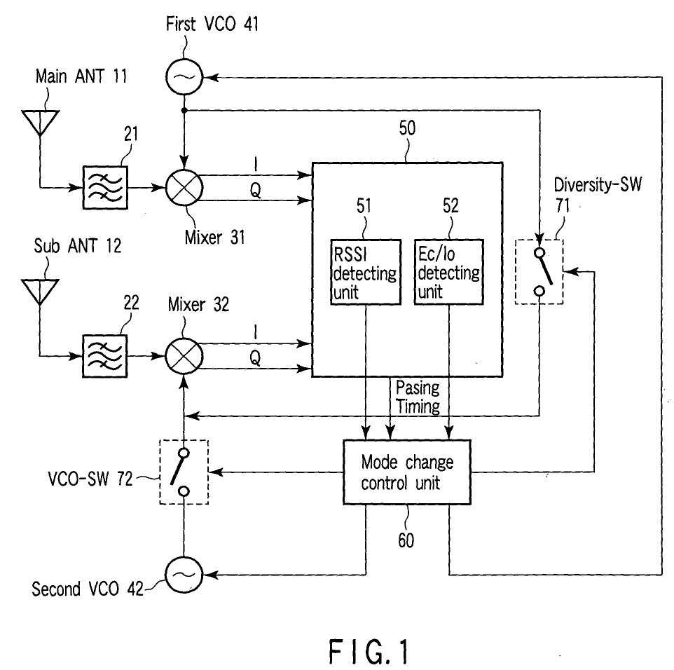

FIG. 1 shows a configuration of a radio reception apparatus according to the embodiment of the present invention. The radio reception apparatus is equivalent to, for example, a receiving system of a mobile radio terminal which establishes communications with a radio base station accommodated in a mobile communications network, and corresponds to 1× speech communications, EV-DO data communications and BCMCS (Broadcast/Multicast Services). The radio reception apparatus comprises a main antenna 11, a sub-antenna 12, bandpass filters 21 and 22, mixers 31 and 32, a first VCO 41, a second VCO 42, a receiving unit 50, a mode change control unit 60, a diversity switch (Diversity SW) 71, and a VCO switch (VCO-SW) 72.

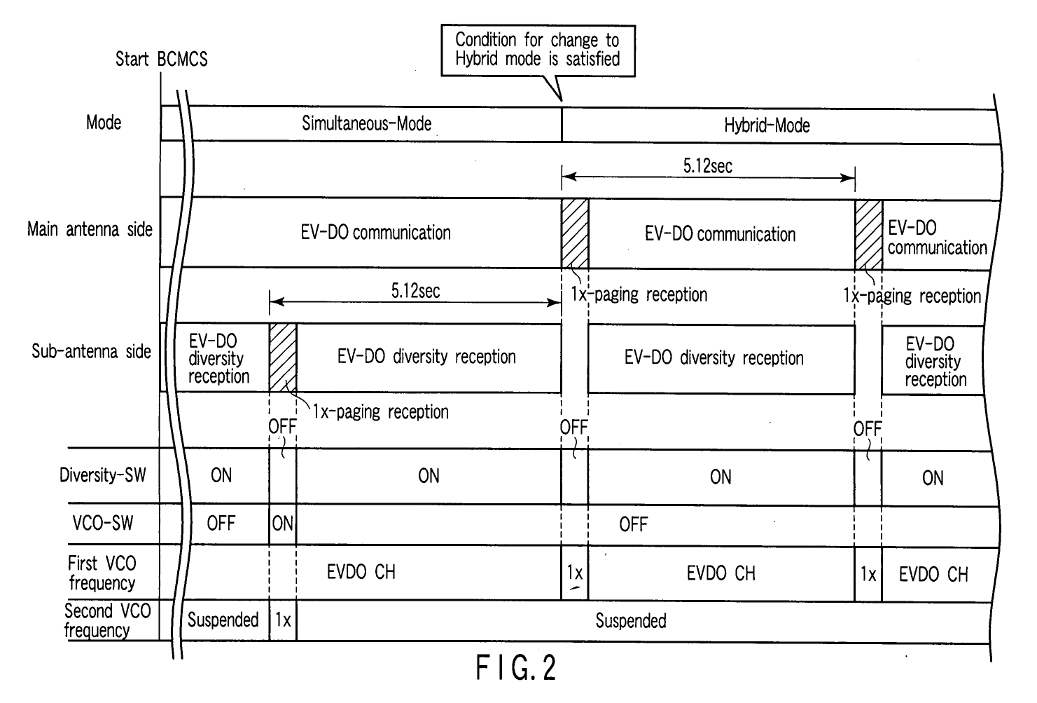

The main antenna 11 is an antenna which receives an RF signal transmitted from a base station (not shown) from space and which has a greater gain than the sub-antenna 12 described later. In a case where the radio reception apparatus is operated for the BCMCS, as shown in FIG. 2, the main antenna 11 is employed as a main antenna of the EV-DO communications, in the Simultaneous-Mode while the main antenna 11 is employed for the reception of 1×-paging signals and the EV-DO communications, which are changed in time, in the Hybrid-Mode.

The sub-antenna 12 is an antenna which receives an RF signal transmitted from a base station (not shown) from space and which has a smaller gain than the main antenna 11 described above. In a case where the radio reception apparatus is operated for the BCMCS, as shown in FIG. 2, the sub-antenna 12 is employed for the diversity reception of EV-DO communications and the reception of 1×-paging signals, which are changed in time, in the Simultaneous-Mode while the sub-antenna 12 is employed for the diversity reception of EV-DO communications when the main antenna 11 is employed for the EV-DO communications, in the Hybrid-Mode.

The diversity reception is implemented by synthesizing the signal received via the main antenna 11 and the signal received via the sub-antenna 12 by the receiving unit 50 described later. In addition, the receiving unit 50 receives the 1×-paging signal and discriminates occurrence of the incoming signal at the radio reception apparatus.

The bandpass filters 21 and 22 are bandpass-type filters which allow the only radio frequency signal in the band used in each of the 1× speech communications and the EV-DO data communications to pass therethrough.

The mixer 31 mixes a local signal generated in the first VCO 41 with the RF signal passing through the bandpass filter 21, downconverts the mixed signal to a baseband signal, and obtains I/Q signals orthogonal to each other.

The mixer 32 mixes a local signal generated in the second VCO 42 with the RF signal passing through the bandpass filter 22, downconverts the mixed signal to a baseband signal, and obtains I/Q signals orthogonal to each other.

At the timing directed by the mode change control unit 60 described later, the first VCO 41 oscillates a local signal of a frequency which is also directed by the mode change control unit 60. For example, in a case where the radio reception apparatus is operated in the BCMCS, as shown in FIG. 2, the first VCO 41 oscillates the local signal of the frequency necessary to receive the signals of the EV-DO channel at the main antenna 11 and the sub-antenna 12, in the Simultaneous-Mode while the first VCO 41 oscillates the local signal of the frequency necessary to receive the 1×-paging signal at the main antenna 11 and the local signal of the frequency necessary to receive the signals of the EV-DO channel at the main antenna 11 and the sub-antenna 12, which are changed at a predetermined timing, in the Hybrid-Mode.

Similarly to the first VCO 41, the second VCO 42 oscillates a local signal of a frequency which is also directed by the mode change control unit 60. For example, in a case where the radio reception apparatus is operated in the BCMCS, as shown in FIG. 2, the second VCO 42 oscillates the local signal of the frequency necessary to receive the 1×-paging signal at the sub-antenna 12, in the Simultaneous-Mode.

The receiving unit 50 inputs the I/Q signals from the mixers 31 and 32, respectively, executes a receiving process such as demodulation, decoding and the like, and reproduces speech data, packet data and the like. At the EV-DO communications, the receiving unit 50 executes diversity reception using the I/Q signals input from the mixers 31 and 32, respectively. In addition, the receiving unit 50 detects the reception timing (called paging timing) of the 1×-paging signal which is transmitted from the base station every 5.12 seconds at the incoming signal awaiting time, from the received signal, and notifies the mode change control unit 60 of the paging timing.

The receiving unit 50 comprises a RSSI (Received Signal Strength Indicator) detecting unit 51 and a Ec/Io detecting unit 52. The RSSI detecting unit 51 measures a receiving power level of the signal received from the base station and notifies the mode change control unit 60 of the measurement result. The Ec/Io detecting unit 52 measures Ec/Io (pilot signal intensity/full received signal intensity) level of the signal received from the base station, and notifies the mode change control unit 60 of the measurement result.

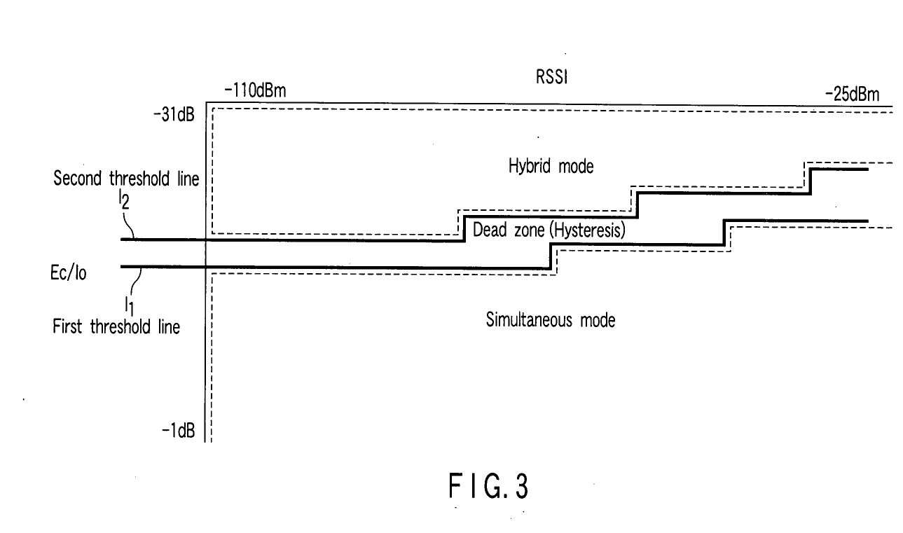

The mode change control unit 60 stores a mode change table shown in FIG. 3. The mode change control unit 60 changes the oscillation timing and frequency of the local signal oscillated by the first VCO 41, the oscillation timing of the local signal oscillated by the second VCO 42, and the diversity switch 71 and the VCO switch 72, as shown in a lower section of FIG. 2, on the basis of the paging timing, the receiving power level, the Ec/Io level and the mode change table that are notified from the receiving unit 50.

The diversity switch 71 is controlled to change as shown in FIG. 2 by the mode change control unit 60, and selectively supplies the local signal oscillated by the first VCO 41 to the mixer 32. In other words, the diversity switch 71 is controlled to be ON state by the mode change control unit 60 when the signal of the EV-DO channel is received via the mixer 32 or controlled to be OFF state when the 1×-paging signal is received.

The VCO switch 72 is controlled to change as shown in FIG. 2 by the mode change control unit 60, and selectively supplies the local signal oscillated by the second VCO 42 to the mixer 32. In other words, when the 1×-paging signal is received via the mixer 32 in the Simultaneous-Mode, the VCO switch 72 is controlled to be ON state by the mode change control unit 60, and supplies the local signal of the frequency necessary to receive the 1×-paging signal oscillated by the second VCO 42. In other cases, the VCO switch 72 is controlled to be OFF state.

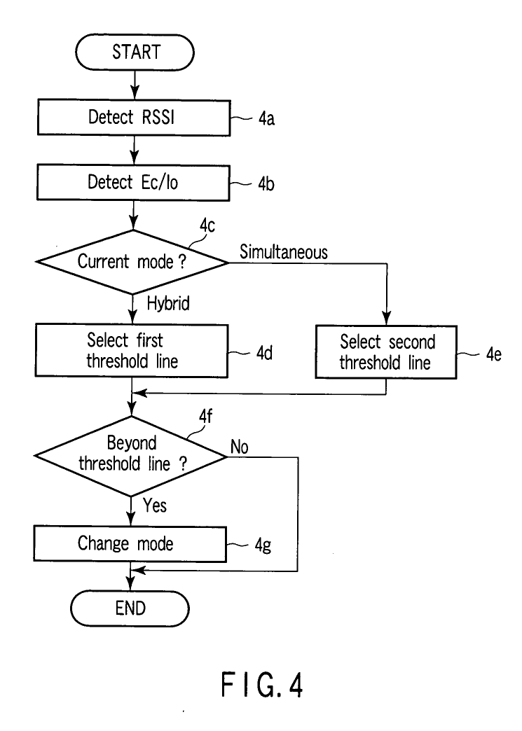

Next, an operation of the radio reception apparatus having the above-described configuration will be described. An operation of changing the Simultaneous-Mode and the Hybrid-Mode will be described below. FIG. 4 is a flowchart showing a control flow of the changing operation, which is executed by the mode change control unit 60. Control programs and control data of the control flow are stored in the mode change control unit 60. When the power of the radio reception apparatus is turned on, the control flow is repeated until the power is turned off.

First, in step 4a, the mode change control unit 60 obtains the receiving power level detected by the RSSI detecting unit 51 from the receiving unit 50. Then the mode change control unit 60 proceeds to step 4b.

In step 4b, the mode change control unit 60 obtains the Ec/Io level detected by the Ec/Io detecting unit 52 from the receiving unit 50. The mode change control unit 60 proceeds to step 4c.

In step 4c, the mode change control unit 60 discriminates the current operation mode. If the current operation mode is the Simultaneous-Mode, the mode change control unit 60 proceeds to step 4e. If the current operation mode is the Hybrid-Mode, the mode change control unit 60 proceeds to step 4d.

In step 4d, the mode change control unit 60 selects first threshold line l₁ of a mode change table shown in FIG. 3 as a discrimination threshold line used in step 4f to be described below. The mode change control unit 60 proceeds to step 4f.

In step 4e, the mode change control unit 60 selects second threshold line l₂ of the mode change table shown in FIG. 3 as the discrimination threshold line used in step 4f to be described below. The mode change control unit 60 proceeds to step 4f.

In step 4f, the mode change control unit 60 discriminates whether or not a combination of the receiving power level obtained in step 4a and the Ec/Io level obtained in step 4b exceeds the threshold line selected in step 4d or step 4e and belongs to the domain of the other mode that is not currently selected, on the table shown in FIG. 3. If the mode change control unit 60 discriminates that the combination of the receiving power level and the Ec/Io level belongs to the domain of the other mode, the mode change control unit 60 proceeds to step 4g. If the mode change control unit 60 discriminates that the combination does not belong to the domain of the other mode, the mode change control unit 60 ends the process.

In step 4g, the mode change control unit 60 changes the current mode to the other mode at the timing of receiving the 1×-paging signal on the basis of the paging timing notified by the receiving unit 50, and ends the process.

For example, if the current mode is the Hybrid-Mode, the mode change control unit 60 selects the first threshold line l₁ in step 4d and discriminates in step 4f whether or not the combination of the receiving power level obtained in step 4a and the Ec/Io level obtained in step 4b exceeds the first threshold line l₁ and belongs to the domain of the Simultaneous-Mode, on the table shown in FIG. 3. If the combination of the receiving power level and the Ec/Io level exceeds the first threshold line l₁ and belongs to the domain of the Simultaneous-Mode, the mode change control unit 60 changes the current mode (Hybrid-Mode) to the Simultaneous-Mode.

If the current mode is the Simultaneous-Mode, the mode change control unit 60 selects the second threshold line l₂ in step 4e and discriminates in step 4f whether or not the combination of the receiving power level obtained in step 4a and the Ec/Io level obtained in step 4b exceeds the second threshold line 12 and belongs to the domain of the Hybrid-Mode, on the table shown in FIG. 3. If the combination of the receiving power level and the Ec/Io level exceeds the second threshold line l₂ and belongs to the domain of the Hybrid-Mode, the mode change control unit 60 changes the current mode (Simultaneous-Mode) to the Hybrid-Mode.

As described above, the change of the operation mode is discriminated by considering not only the receiving power level, but also the Ec/Io level, and the Simultaneous-Mode is not changed to the Hybrid-Mode unless at least the Ec/Io level exceeds the second threshold line l₂.

Therefore, since the Simultaneous-Mode is not changed to the Hybrid-Mode for the simple reason that the receiving power level is lowered, in the radio reception apparatus having the above-described configuration, the Simultaneous-Mode can easily be maintained, interruption of the EV-DO communications occurring in the Hybrid-Mode, which results from the reception of the 1×-paging signal, can be restricted and, as a result, deterioration of the receiving quality of the signal subjected to the multicast transmission can be reduced.

In addition, in the radio reception apparatus having the above-described configuration, the threshold line l₁ for determination of the change from the Hybrid-Mode to the Simultaneous-Mode is different from the threshold line l₂ for determination of the change from the Simultaneous-Mode to the Hybrid-Mode, and the hysteresis characteristic is maintained. For this reason, since the mode change does not occur between the two threshold lines l₁ and l₂, unnecessary mode change can be restricted and stable communications can be executed.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

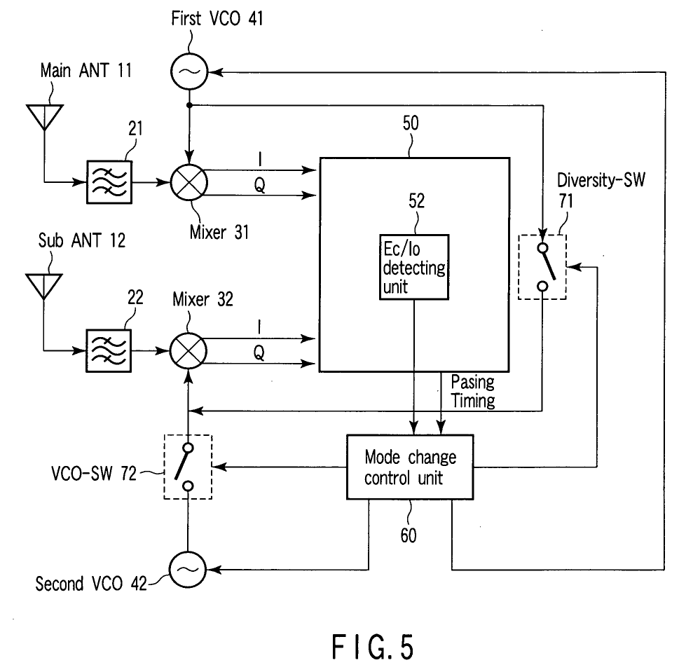

For example, the discrimination of change of the operation mode is executed on the receiving power level and the Ec/Io level, in the above-described embodiment. However, the discrimination of change of the operation mode may be executed on the Ec/Io level alone, in a configuration as shown in FIG. 5. In the radio reception apparatus shown in FIG. 5, since the discrimination of change of the operation mode is executed not on the receiving power level but on the Ec/Io level alone, the discrimination in the vertical axis direction is executed in FIG. 3.

Such discrimination of change of the operation mode on the Ec/Io level alone is often more effective than the discrimination of change of the operation mode on the receiving power level alone. For example, even in a case where the receiving power level is preferable (high), the Ec/Io level is deteriorated in an urban area, in the time zone such as evening, because of high Traffic. In this case, the discrimination is executed on the Ec/Io level rather than the control of change of the mode on the receiving power level alone. If the Ec/Io level is not good, the 1×-paging signal is received in the main antenna 11 system (Simultaneous-Mode). Stable awaiting of conversation can be thereby executed.

The present invention can also be otherwise variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio reception apparatus having a first communications mode and a second communications mode and receiving a radio signal from a base station accommodated in a mobile communications network in one of the communications mode, the apparatus comprising:
a measuring unit which obtains a rate of a desired signal intensity to a full received signal intensity, from a signal received from the base station; and
a receiving unit which receives the radio signal from the base station by selectively changing the first communications mode and the second communications mode in accordance with the rate obtained by the measuring unit.

2. The apparatus according to claim 1, wherein the receiving unit selects the first communications mode if the rate is higher than a first threshold value, and selects the second communications mode if the rate is lower than a second threshold value that is lower than the first threshold value.

3. The apparatus according to claim 1, wherein the receiving unit comprises a first antenna and a second antenna;
in the first communications mode, the receiving unit executes diversity reception by synthesizing a signal received via the first antenna and a signal received via the second antenna, interrupts the diversity reception employing the second antenna at a preset timing, and discriminates presence of a call signal from the signal received via the second antenna; and
in the second communications mode, the receiving unit executes diversity reception by synthesizing a signal received via the first antenna and a signal received via the second antenna, interrupts the diversity reception employing the second antenna at a preset timing, and discriminates presence of a call signal from the signal received via the first antenna.

4. A radio reception apparatus having a first communications mode and a second communications mode and receiving a radio signal from a base station accommodated in a mobile communications network in one of the communications mode, the apparatus comprising:
a first measuring unit which obtains a signal intensity of a signal received from the base station;
a second measuring unit which obtains a rate of a desired signal intensity to a full received signal intensity, from the signal received from the base station; and
a receiving unit which receives the radio signal from the base station by selectively changing the first communications mode and the second communications mode in accordance with the signal intensity obtained by the first measuring unit and the rate obtained by the second measuring unit.

5. The apparatus according to claim 4, wherein the receiving unit selects the first communications mode if a combination of the signal intensity and the rate satisfies a first condition, and selects the second communications mode if the combination of the signal intensity and the rate is lower than a second condition that indicates a worse receiving environment than the first condition.

6. The apparatus according to claim 4, wherein the receiving unit comprises a first antenna and a second antenna;
in the first communications mode, the receiving unit executes diversity reception by synthesizing a signal received via the first antenna and a signal received via the second antenna, interrupts the diversity reception employing the second antenna at a preset timing, and discriminates presence of a call signal from the signal received via the second antenna; and
in the second communications mode, the receiving unit executes diversity reception by synthesizing a signal received via the first antenna and a signal received via the second antenna, interrupts the diversity reception employing the second antenna at a preset timing, and discriminates presence of a call signal from the signal received via the first antenna.

7. A radio reception method employed in a radio reception apparatus having a first communications mode and a second communications mode and receiving a radio signal from a base station accommodated in a mobile communications network in one of the communications mode, the method comprising:
a measuring step of obtaining a rate of a desired signal intensity to a full received signal intensity, from a signal received from the base station; and
a receiving step of receiving the radio signal from the base station by selectively changing the first communications mode and the second communications mode in accordance with the rate obtained in the measuring step.

8. The method according to claim 7, wherein in the receiving step, the first communications mode is selected if the rate is higher than a first threshold value, and the second communications mode is selected if the rate is lower than a second threshold value that is lower than the first threshold value.

9. The method according to claim 7, wherein in the receiving step, in the first communications mode, diversity reception is executed by synthesizing a signal received via a first antenna and a signal received via the second antenna, the diversity reception employing the second antenna is interrupted at a preset timing, and presence of a call signal is discriminated from the signal received via the second antenna; and in the second communications mode, the diversity reception is executed by synthesizing a signal received via the first antenna and a signal received via the second antenna, the diversity reception employing the second antenna is interrupted at a preset timing, and presence of a call signal is discriminated from the signal received via the first antenna.

10. A radio reception method employed in a radio reception apparatus having a first communications mode and a second communications mode and receiving a radio signal from a base station accommodated in a mobile communications network in one of the communications mode, the method comprising:
a first measuring step of obtaining a signal intensity of a signal received from the base station;
a second measuring step of obtaining a rate of a desired signal intensity to a full received signal intensity, from the signal received from the base station; and
a receiving step of receiving the radio signal from the base station by selectively changing the first communications mode and the second communications mode in accordance with the signal intensity obtained in the first measuring step and the rate obtained in the second measuring step.

11. The method according to claim 10, wherein in the receiving step, the first communications mode is selected if a combination of the signal intensity and the rate satisfies a first condition, and selects the second communications mode if the combination of the signal intensity and the rate is lower than a second condition that indicates a worse receiving environment than the first condition.

12. The method according to claim 10, wherein the receiving step, in the first communications mode, diversity reception is executed by synthesizing a signal received via a first antenna and a signal received via the second antenna, the diversity reception employing the second antenna is interrupted at a preset timing, and presence of a call signal is discriminated from the signal received via the second antenna; and in the second communications mode, the diversity reception is executed by synthesizing a signal received via the first antenna and a signal received via the second antenna, the diversity reception employing the second antenna is interrupted at a preset timing, and presence of a call signal is discriminated from the signal received via the first antenna.
